(19) United States
(12) Patent Application Publication
(10) Pub. No.: US 2008/0238024 A1
(43) Pub. Date: Oct. 2, 2008

(54) Hands Free Baby Stroller Attachment

(76) Inventors: Gerald Heidenreich, San Anselmo, CA (US); Erik Gambera, Kentfield, CA (US); Jill Ottaviano, Alameda, CA (US)

Correspondence Address: ERIK GAMBERA, 1 INMAN AVE., KENTFIELD, CA, 94904, US

(21) Appl. No.: 11/692,064

(22) Filed: Mar. 27, 2007

(51) Int. Cl. B62M 29/00

(52) U.S. Cl. 280/266; 280/1.5

(57) ABSTRACT

An apparatus designed to allow a runner to run/jog with a baby jogger by allowing natural running arm movement through the use of a twin shock absorbing connector arm assembly being attached at one end to a baby jogger and the other to the waist of the jogger by means of a waist belt with pivots at either end of the arm assembly to allow for variation in size/height of jogger and operator.

### BACKGROUND OF THE INVENTION

The invention relates to the interface between a runner/jogger/walker and a modern style baby stroller designed for running/jogging/walking by improving the ability of the operator to run or jog with a normal stride allowing for free arm movement and simultaneous control of the stroller.

These types of strollers or “baby joggers” are designed for a more rigorous use than normal baby strollers and generally have three larger wheels allowing them to be used for running rather than just walking, and this invention will allow for the user to remove their hands from the control bar and run normally, while insulating the child from the vibration of the runner.

### SUMMARY OF THE INVENTION

This invention allows for a cushioning effect for the child during hands free exercising for the operator by means of a shock absorbing stroller attachment assembly between the stroller/jogger and the operator. This invention will reduce significantly shaking/jerking of a child in a stroller/jogger, especially a young childs head.

### BRIEF DESCRIPTION OF THE DRAWINGS

The invention will be shown and described with reference to drawings, of which:

FIG. 1 is an illustration of the stroller and operator connected by the invention;

FIG. 2 is an illustration of the stroller and operator connected by the invention in an isometric view;

FIG. 3 is an illustration of the double acting internal shock absorbing system inside of the attachment rods;

### DETAILED DESCRIPTION

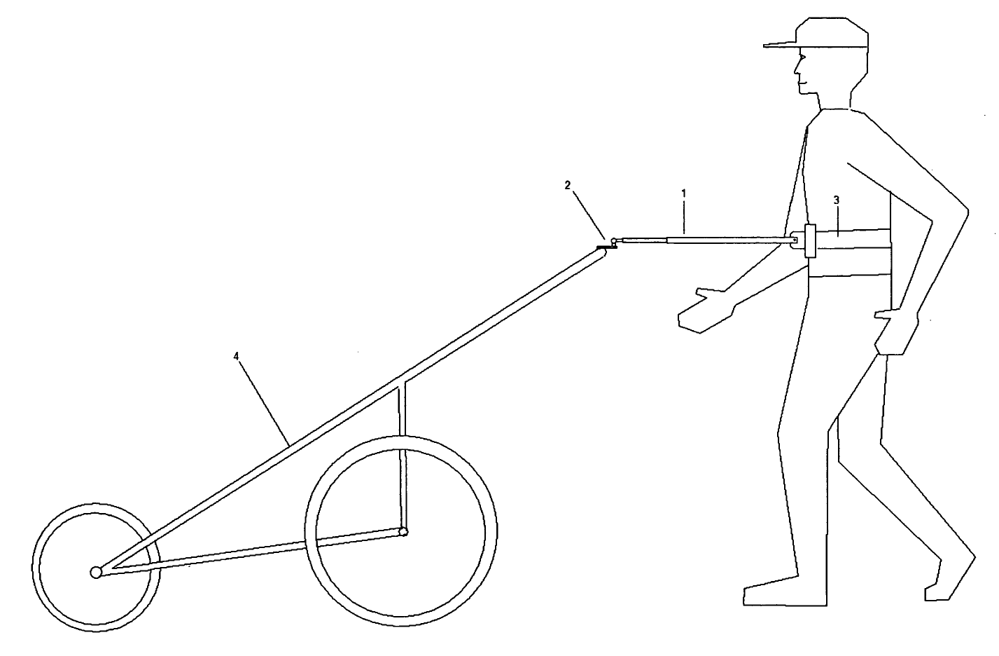

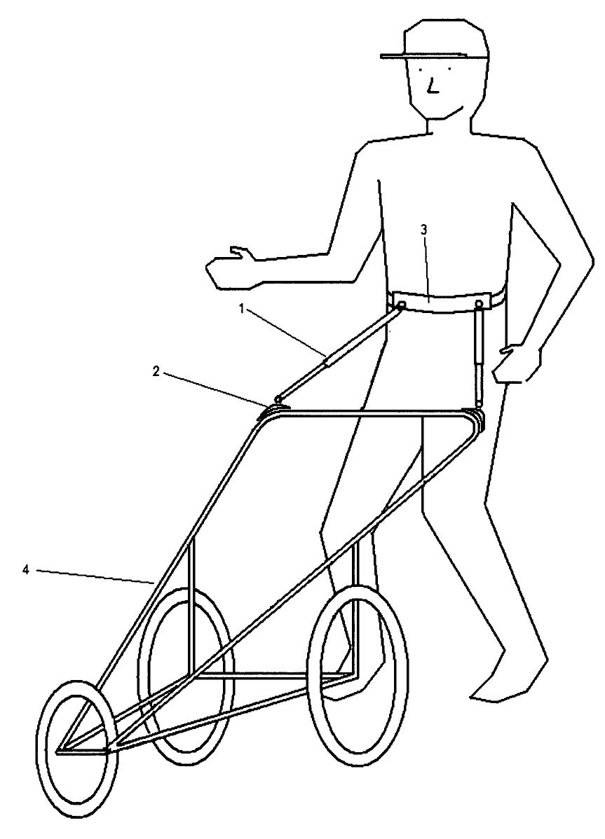

FIGS. 1 and 2 are illustrations of the invention in use showing the operator 5 attached to the stroller 4 by means of the invention waistbelt 3 to connecting rods 1 and flexible fitments 2 at jogger steering bar and waistbelt

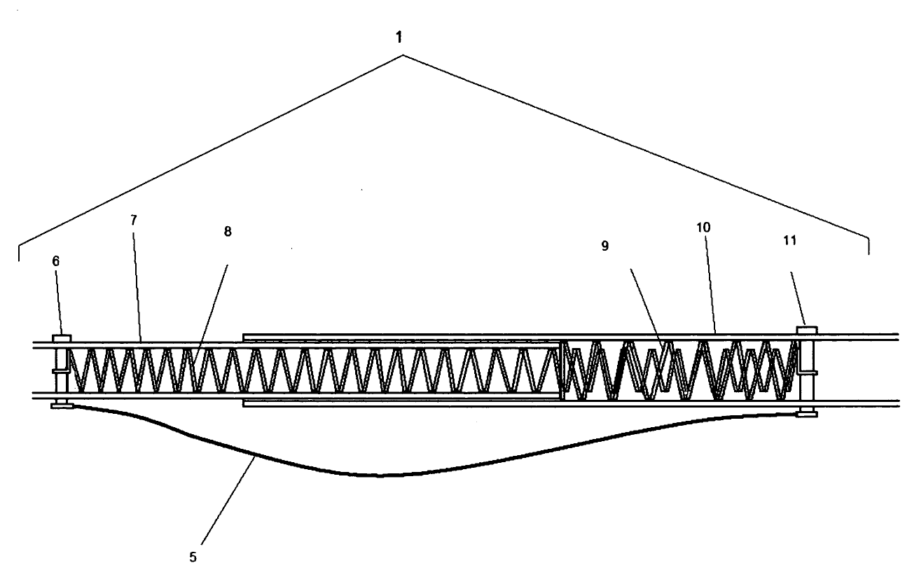

FIG. 3 is an illustration of the internal double acting shock absorbing system with both a compression 8 and extension 9 spring attached at retaining pins 6 and 11 used in tandem to allow for movement of rods 7 and 10 independently of each other, 5 is a travel limiting cable. It should be noted that this spring system could be effectively duplicated by means of other moveable materials such as an elastomer material or a compressed air chamber etc. that will essentially allow for a neutral middle position with equal resistance to input forces forward and backward.

1. An attachment to allow for an operator of a baby jogger to walk or run without using hands or arms for steering input, thereby allowing natural swinging movement of operators arms.

2. The apparatus of claim 1 comprises a two rod assembly between six inches and three feet in length for attaching the jogger to the body of the operator.

3. The apparatus of claim 2 consists of each individual rod assembly being made of two cylindrical sections featuring a shock absorbing system allowing forward and backwards movement.

4. The apparatus of claim 3 consists of two different diameter rods one within the other to allow for free lengthways movement while remaining rigid side to side.

5. The apparatus of claim 3 allows for forwards and backwards shock absorbing by means of a double spring, air or elastomer system enclosed within the rod assembly.

6. The apparatus of claim 2 comprises a waistbelt with two attachment points at one end of the rod assembly and two fixable attachment points on the jogger steering bar. Both ends of the rod assembly would have a flexible fitment to allow for different heights of the jogger unit and operator.

7. The apparatus of claim 5 consists of a double action spring or elastomer/air spring that produces a shock absorbing effect from either forward or backward input forces applied at either end of the attachment rod assembly.

8. The apparatus of claim 6 comprises a ball joint end assembly that allows for horizontal, vertical and rotational movement at all four ends of the rod assembly using a ball joint or universal joint or similar movable connection.

9. The apparatus of claim 8 is attached to the waistbelt in two points between 2 and 20 inches apart and is attached at the jogger steering bar with two mounting plates between 2 and 36 inches.
